(19) United States
(12) Patent Application Publication
(10) Pub. No.: US 2017/0076744 A1
(43) Pub. Date: Mar. 16, 2017

(54) MAGNETIC RECORDING DEVICE

(71) Applicant: Kabushiki Kaisha Toshiba, Minato-ku (JP)

(72) Inventors: Masayuki Takagishi, Kunitachi (JP); Kenichiro Yamada, Minato (JP); Tomoyuki Maeda, Kawasaki (JP)

(73) Assignee: Kabushiki Kaisha Toshiba, Minato-ku (JP)

(21) Appl. No.: 15/262,663

(22) Filed: Sep. 12, 2016

(30) Foreign Application Priority Data
Sep. 14, 2015 (JP) 2015-181167

(51) Int. Cl. G11B 5/31; G11B 5/127

(52) U.S. Cl. CPC G11B 5/3116; G11B 5/1278; G11B 5/3146

(57) ABSTRACT

According to one embodiment, a magnetic recording device includes a magnetic recording medium and a magnetic head. The magnetic head includes a magnetic pole and a trailing shield. The magnetic pole has a medium-opposing surface opposing the magnetic recording medium. The medium-opposing surface has a magnetic pole length along a first direction. The first direction is from the magnetic pole toward the trailing shield. The magnetic pole length is shorter than a track pitch of the magnetic recording medium.

### CROSS-REFERENCE TO RELATED APPLICATIONS

This application is based upon and claims the benefit of priority from Japanese Patent Application No. 2015-181167, filed on Sep. 14, 2015; the entire contents of which are incorporated herein by reference.

### FIELD

Embodiments described herein relate generally to a magnetic recording device.

### BACKGROUND

Information is recorded in a magnetic storage medium such as a HDD (Hard Disk Drive), etc., using a magnetic head. For example, perpendicular magnetic recording is advantageous for high density recording. It is desirable to increase the recording density of the magnetic recording device.

### BRIEF DESCRIPTION OF THE DRAWINGS

FIG. 1A to FIG. 1C are schematic views illustrating a magnetic recording device according to a first embodiment;

FIG. 2A and FIG. 2B are schematic plan views illustrating the magnetic recording device according to the first embodiment;

FIG. 3A to FIG. 3C are graphs of characteristics of the magnetic recording device;

FIG. 4A and FIG. 4B are graphs of characteristics of the magnetic recording device;

FIG. 5A and FIG. 5B are schematic views illustrating characteristics of magnetic recording devices;

FIG. 6 is a graph of characteristics of the magnetic recording device;

FIG. 7 is a graph of characteristics of the magnetic recording devices;

FIG. 8 is a schematic perspective view illustrating the magnetic recording device according to the first embodiment;

FIG. 9 is a schematic perspective view illustrating a portion of the magnetic recording device according to the first embodiment;

FIG. 10 is a schematic perspective view illustrating the magnetic recording device according to the embodiment; and

FIG. 11A and FIG. 11B are schematic perspective views illustrating portions of the magnetic recording device.

### DETAILED DESCRIPTION

According to one embodiment, a magnetic recording device includes a magnetic recording medium and a magnetic head. The magnetic head includes a magnetic pole and a trailing shield. The magnetic pole has a medium-opposing surface opposing the magnetic recording medium. The medium-opposing surface has a magnetic pole length along a first direction. The first direction is from the magnetic pole toward the trailing shield. The magnetic pole length is shorter than a track pitch of the magnetic recording medium.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

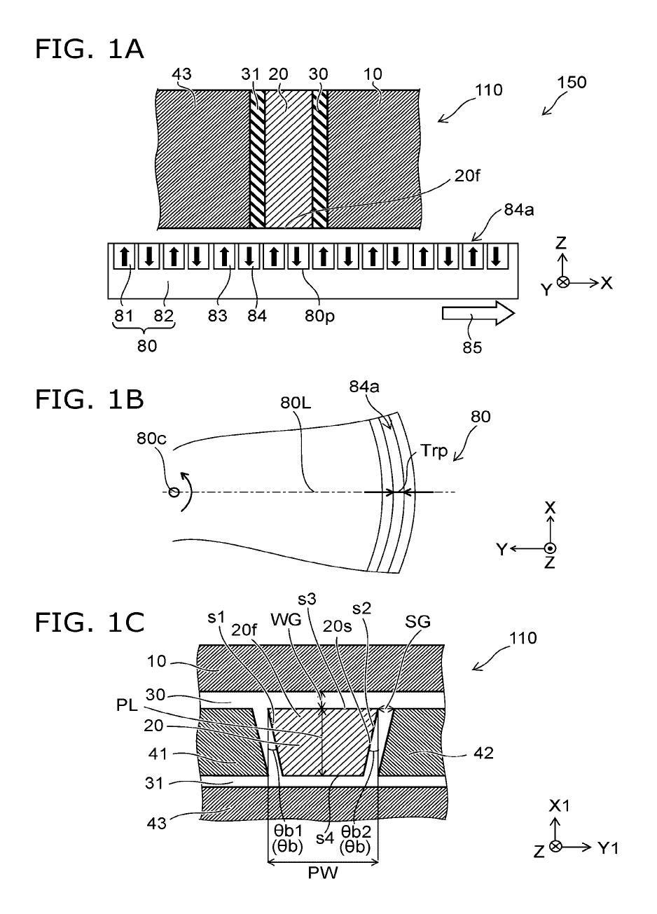

FIG. 1A to FIG. 1C are schematic views illustrating a magnetic recording device according to a first embodiment.

FIG. 1A is a cross-sectional view. FIG. 1B is a plan view showing a magnetic recording medium provided in the magnetic recording device. FIG. 1C is a plan view showing a magnetic head provided in the magnetic recording device.

As shown in FIG. 1A, the magnetic recording device 150 according to the embodiment includes a magnetic recording medium 80 and a magnetic head 110. The magnetic head 110 includes a magnetic pole 20. The magnetic pole 20 has a medium-opposing surface 20f. The medium-opposing surface 20f opposes the magnetic recording medium 80. The medium-opposing surface 20f corresponds to a medium-opposing surface (an Air Bearing Surface (ABS)) of the magnetic head 110.

A direction from the magnetic recording medium 80 toward the magnetic head 110 (the magnetic pole 20) is taken as a Z-axis direction. The Z-axis direction is the height direction. The Z-axis direction is substantially perpendicular to the medium-opposing surface 20f. One direction perpendicular to the Z-axis direction is taken as an X-axis direction. A direction perpendicular to the Z-axis direction and the X-axis direction is taken as a Y-axis direction.

The magnetic recording medium 80 moves relative to the magnetic head 110 along a medium movement direction 85. The medium movement direction 85 is taken as the X-axis direction. The X-axis direction corresponds to the down-track direction. The Y-axis direction corresponds to the track width direction.

The magnetic recording medium 80 includes, for example, a medium substrate 82, and a magnetic recording layer 81 provided on the medium substrate 82. Multiple recorded bits are provided in the magnetic recording layer 81. A magnetization 83 of each of the multiple recorded bits 84 is controlled by a magnetic field applied from the magnetic head 110 (a recording magnetic field generated by the magnetic pole 20). Thereby, a writing operation is implemented. The magnetic recording layer 81 is, for example, a perpendicular magnetic recording layer. Thus, the magnetic recording medium 80 includes, for example, a perpendicular magnetic recording layer.

The recording track corresponds to a column 84a of the recorded bits 84 of the magnetic recording. The extension direction of the column 84a of the recorded bits 84 corresponds to the down-track direction.

The magnetic head 110 includes the magnetic pole 20 and a shield 10. The magnetic pole 20 writes information to the magnetic recording medium. The shield 10 is a trailing shield. A designated portion 80p of the magnetic recording medium 80 opposes the shield 10 after opposing the magnetic pole 20.

A gap insulating unit 30 is provided in the magnetic head 110 between the magnetic pole 20 and the shield 10. In the example, a shield 43 is further provided. An insulating unit 31 is provided between the shield 43 and the magnetic pole 20. The gap insulating unit 30 and the insulating unit 31 include, for example, a material including an oxide of aluminum.

The magnetic recording medium 80 has, for example, a disk configuration.

FIG. 1B illustrates a portion of the magnetic recording medium 80. The magnetic recording medium 80 rotates with a medium rotation axis 80c as the center. For example, the extension direction of the column 84a of the recorded bits 84 has a circular configuration having the medium rotation axis 80c as the center. In the embodiment, the size of the magnetic pole 20 opposing the magnetic recording medium 80 is markedly smaller than the size of the entire magnetic recording medium 80. Accordingly, when considering the extension direction of the column 84a of the recorded bits 84 in the magnetic recording medium 80, the extension direction of the column 84a may be considered to be a straight line along the circumferential direction of a circle having the medium rotation axis 80c as the center. In other words, the magnetic recording medium 80 includes a portion that opposes the magnetic pole 20. Focusing on this portion, the extension direction of the column 84a at the vicinity of this portion is substantially aligned with a straight line along the circumferential direction of the circle having the medium rotation axis 80c as the center. The columns 84a of the recorded bits 84 extend in substantially concentric circular configurations having the medium rotation axis 80c as the center.

As shown in FIG. 1B, a track pitch Trp of the magnetic recording medium 80 corresponds to the pitch of the multiple columns 84a. The direction of the track pitch Trp is aligned with a straight line 80L passing through the medium rotation axis 80c (a straight line passing through the medium rotation axis 80c parallel to the medium-opposing surface 20f). On the other hand, the down-track direction is substantially perpendicular to the straight line 80L.

FIG. 1C is a plan view of the magnetic head 110 as viewed from the medium-opposing surface 20f side. As described above, the magnetic pole 20, the shield 10, and the shield 43 are provided in the magnetic head 110; and a first side shield 41 and a second side shield 42 are further provided in the magnetic head 110. The magnetic pole 20 is disposed between the first side shield 41 and the second side shield 42. The first side shield 41, the second side shield 42, and the magnetic pole 20 are disposed between the shield 10 and the shield 43.

The direction from the magnetic pole 20 toward the shield 10 is taken as an X1-axis direction (a first direction). The X1-axis direction is substantially perpendicular to the Z-axis direction. A direction perpendicular to the X1-axis direction and perpendicular to the Z-axis direction is taken as a Y1-axis direction. The Y1-axis direction is parallel to the medium-opposing surface 20f and perpendicular to the direction from the magnetic pole 20 toward the shield 10. The medium-opposing surface 20f is aligned with the X1-Y1 plane. The surface of the magnetic pole 20 opposing the shield 10 is aligned with the Y1-axis direction.

The information is written to the magnetic recording medium 80 by the magnetic field generated between the magnetic pole 20 and the shield 10. The spacing (the distance along the X1-axis direction) between the magnetic pole 20 and the shield 10 corresponds to a write gap WG. The spacing (the distance along the Y1-axis direction) between the magnetic pole 20 and the first side shield 41 corresponds to a side gap SG. The spacing (the distance along the Y1-axis direction) between the magnetic pole 20 and the second side shield 42 corresponds to the side gap SG. The length along the X1-axis direction of the magnetic pole 20 corresponds to a magnetic pole length PL. The length along the Y1-axis direction of the magnetic pole 20 corresponds to a magnetic pole width PW.

A side surface 20s of the magnetic pole 20 is tilted with respect to the X1-axis direction. The angle of the tilt corresponds to a bevel angle θb. The medium-opposing surface 20f has a first side 51, a second side s2, a third side s3, and an end portion s4. The first side s1 opposes the first side shield 41. The second side s2 opposes the second side shield 42. The third side s3 opposes the shield 10. The end portion s4 is the side of the magnetic pole 20 opposite to the third side s3.

The third side s3 is substantially aligned with the Y1-axis direction. The first side s1 intersects the Y1-axis direction. When the skew angle described below is 0, the third side s3 is substantially aligned with the straight line 80L passing through the medium rotation axis 80c. For example, the length along the Y1-axis direction of the third side s3 is longer than the length along the Y1-axis direction of the end portion s4.

The first side s1 is tilted with respect to the Y1-axis direction. The first side s1 is tilted with respect to the X1-axis direction. The angle between the first side s1 and the X1-axis direction (the direction from the magnetic pole 20 toward the shield 10) is taken as a first bevel angle θb1. The second side s2 intersects the Y1-axis direction. The second side s2 is tilted with respect to the Y1-axis direction. The second side s2 is tilted with respect to the X1-axis direction. The angle between the second side s2 and the X1-axis direction is taken as a second bevel angle θb2. The first bevel angle θb1 is, for example, the outer bevel angle. The second bevel angle θb2 is the inner bevel angle. The first bevel angle θb1 may be substantially the same as the second bevel angle θb2. The first bevel angle θb1 may be different from the second bevel angle θb2. The first bevel angle θb1 and the second bevel angle θb2 together may be called the bevel angle θb.

In the embodiment, the magnetic pole length PL is set to be short. For example, the magnetic pole length PL is shorter than the track pitch Trp of the magnetic recording medium 80.

For example, the track pitch Trp of the magnetic recording medium 80 is determined by evaluating the magnetic recording medium 80 using a magnetic force microscope (Magnetic Force Microscopy (MFM)), etc. On the other hand, the track pitch Trp can be calculated based on the EWAC (the Erasure Width of the AC pattern, e.g., referring to the specification of U.S. Pat. No. 8,804,281). The value calculated based on the EWAC corresponds to the “smallest possible track pitch.” The “smallest possible track pitch” is a track pitch that is practically used in the magnetic recording device. The track pitch Trp that is determined from the evaluation by the magnetic force microscope matches the value calculated based on the EWAC.

It is generally considered that as the surface area of the magnetic pole 20 is reduced, the magnetic field (the recording magnetic field) generated by the magnetic pole 20 decreases, and the efficiency of the recording of the information to the magnetic recording medium 80 decreases. The magnetic pole width PW of the magnetic pole 20 directly affects the track pitch Trp. By setting the magnetic pole width PW to be narrow, the track pitch can be smaller; and high density recording is possible. To this end, it is generally considered to be favorable to increase the surface area of the magnetic pole 20 (the surface area of the medium-opposing surface 20f) while reducing the magnetic pole width PW. Therefore, the magnetic pole length PL lengthens. On the other hand, in an actual magnetic recording device, a skew angle exists; and in the case where the bevel angle θb is set to be excessively small, the characteristics at the positions where the skew angle is large degrade abruptly. Therefore, as a general technical idea, it is attempted to provide a magnetic pole having a triangular configuration in which the magnetic pole length PL is long while maintaining a bevel angle θb that is about the maximum skew angle or less.

However, according to investigations by the inventor of the application, it was found that recording with good characteristics is possible in an actual magnetic recording device by shortening the magnetic pole length PL and reducing the bevel angle θb. In other words, practically, the effective magnetic field (recording magnetic field) that is generated by the magnetic pole 20 is maintained to be large even in the case where the surface area of the magnetic pole 20 is reduced. The magnetic pole length PL is set to be short in the embodiment. Specifically, for example, the magnetic pole length PL is set to be shorter than the track pitch Trp of the magnetic recording medium 80. Thereby, a high recording density at which recording can be effectively performed is obtained at conditions considering the skew angle.

The skew angle will now be described.

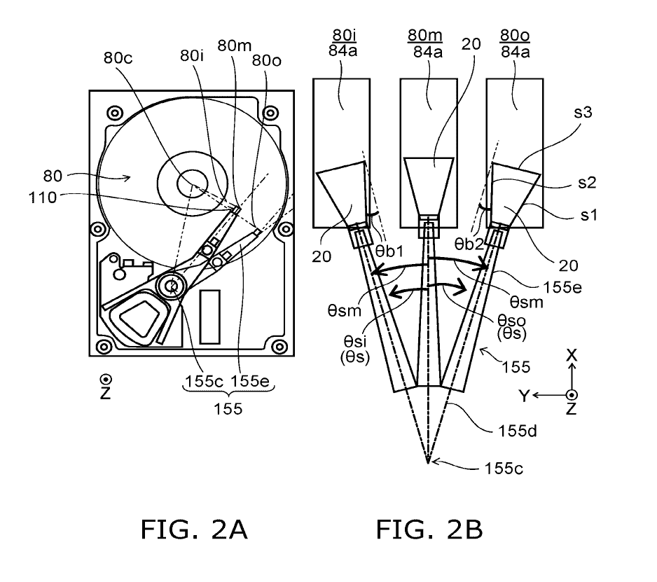

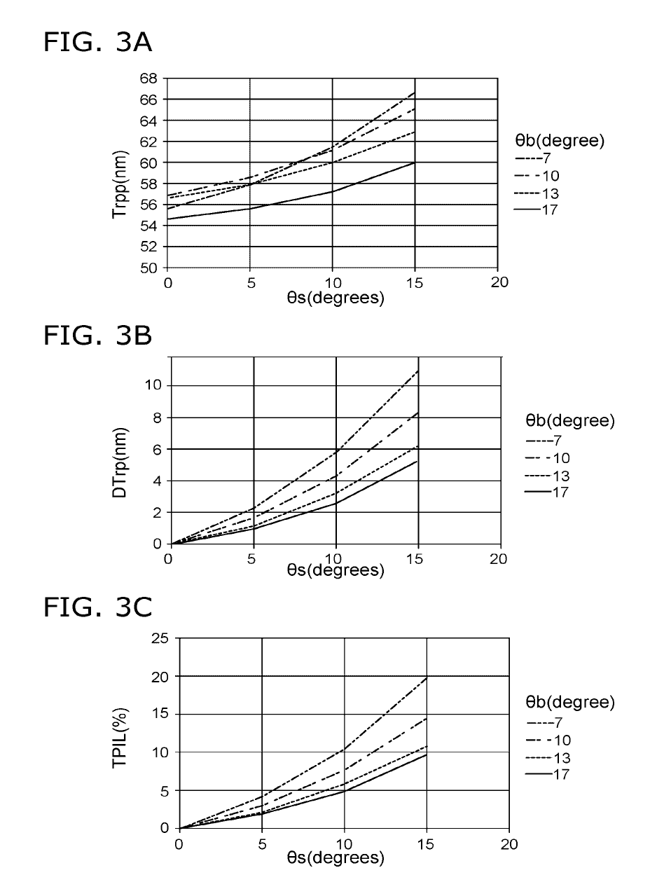

FIG. 2A and FIG. 2B are schematic plan views illustrating the magnetic recording device according to the first embodiment.

As shown in FIG. 2A, the magnetic recording device further includes an arm 155 in addition to the magnetic recording medium 80 and the magnetic head 110. The arm 155 includes an arm axis 155c and an extension portion 155e. The extension portion 155e rotates with the arm axis 155c as the center. The extension portion 155e extends along an arm extension direction 155d. The magnetic head 110 is fixed to the extension portion 155e. Namely, the magnetic pole 20 is fixed to the extension portion 155e.

As shown in FIG. 2A, the magnetic head 110 is moved through an inner circumferential portion 80i, a middle circumferential portion 80m, and an outer circumferential portion 80o of the magnetic recording medium 80 by the rotation of the arm 155 (the rotation of the extension portion 155e).

FIG. 2B shows the relative relationship between the magnetic pole 20 and the column 84a of the recorded bits 84 of the magnetic recording medium 80. Three states that correspond to the inner circumferential portion 80i, the middle circumferential portion 80m, and the outer circumferential portion 80o of the magnetic recording medium 80 are shown in FIG. 2B. As shown in FIG. 2B, for example, the arm extension direction 155d of the extension portion 155e of the arm 155 is aligned with the direction of the column 84a at the middle circumferential portion 80m. The arm extension direction 155d of the extension portion 155e of the arm 155 intersects the direction of the column 84a at the inner circumferential portion 80i. The arm extension direction 155d of the extension portion 155e of the arm 155 intersects the direction of the column 84a at the outer circumferential portion 80o. The intersecting directions are reversed between the inner circumferential portion 80i and the outer circumferential portion 80o.

The angle (a skew angle θs) between the direction of the column 84a of the recorded bits 84 and the direction relating to the magnetic pole 20 (the X1-axis direction and the Y1-axis direction) changes with the movement of the extension portion 155e of the arm 155.

The angle (the skew angle θs) between the arm extension direction 155d and the direction of the column 84a of the recorded bits 84 (the down-track direction) is different between the inner circumferential portion 80i and the outer circumferential portion 80o.

For example, the angle between the arm extension direction 155d and the direction of the column 84a of the recorded bits 84 (the down-track direction) at the inner circumferential portion 80i is taken as an inner skew angle θsi. The angle between the arm extension direction 155d and the direction of the column 84a of the recorded bits 84 (the down-track direction) at the outer circumferential portion 80o is taken as an outer skew angle θso. The directions of the angles are reversed and the polarities of the angles are reversed between the inner skew angle θsi and the outer skew angle θso. The maximum value of the absolute value of the inner skew angle θsi may be substantially the same as the maximum value of the absolute value of the outer skew angle θso. The maximum value of the absolute value of the inner skew angle θsi may be different from the maximum value of the absolute value of the outer skew angle θso.

For example, at the outer circumferential portion 800, the second side s2 is substantially aligned with the direction of the column 84a of the recorded bits 84 (the down-track direction). At the outer circumferential portion 800, the angle between the first side 51 and the direction of the column 84a of the recorded bits 84 is large. On the other hand, at the inner circumferential portion 80i, the first side s1 is substantially aligned with the direction of the column 84a of the recorded bits 84. At the inner circumferential portion 80i, the angle between the second side s2 and the direction of the column 84a of the recorded bits 84 is large.

Thus, the angle between the side of the magnetic pole 20 and the direction of the column 84a of the recorded bits 84 (the down-track direction) is different between the inner circumferential portion 80i and the outer circumferential portion 800. The change of the angle between the side of the magnetic pole 20 and the down-track direction is large when the maximum value of the absolute value of the skew angle Os is large.

Practically, it may be considered that the characteristics at the outer circumferential portion 80o are substantially the same as the characteristics at the inner circumferential portion 80i. In the case where the rotational speed of the magnetic recording medium 80 is high, a characteristic difference may occur due to the difference between the relative speeds of the magnetic recording medium 80 and the magnetic head 110; and a characteristic difference may occur due to a nonuniformity between locations inside the magnetic recording medium 80. The relationship between the bevel angle θb and the skew angle θs described below is substantially the same even when such characteristic differences exist.

The characteristics of the inner circumferential portion 80i will now be described. The description recited below is applicable also to the outer circumferential portion 800. The maximum value of the absolute value of the inner skew angle θsi is taken as a maximum skew angle θsm. The maximum skew angle θsm may be the maximum value of the absolute value of the outer skew angle θso. The maximum skew angle θsm may be the smaller of the maximum value of the absolute value of the inner skew angle θsi and the maximum value of the absolute value of the outer skew angle θso. An example of the recording characteristics when changing the skew angle θs and the bevel angle θb (the first bevel angle θb1) will now be described.

FIG. 3A to FIG. 3C are graphs of characteristics of the magnetic recording device.

These figures illustrate simulation results of the magnetic recording device. In the simulation, the magnetic pole length PL is 90 nm; and the magnetic pole width PW is 40 nm.

In these figures, the horizontal axis is the skew angle θs. The vertical axis of FIG. 3A is a recordable track pitch Trpp. The vertical axis of FIG. 3B is a difference DTrp of the track pitch. The vertical axis of FIG. 3C is a track pitch loss TPIL.

In FIG. 3A, the recordable track pitch Trpp is calculated from the write width of the 2T signal recorded in the magnetic recording medium 80. As shown in FIG. 3A, the recordable track pitch Trpp is large when the skew angle θs is large. For example, when the skew angle θs is 15 degrees, the recordable track pitch Trpp is small when the bevel angle θb is large. The change of the recordable track pitch Trpp with respect to the bevel angle θb is small when the skew angle θs is small (e.g., when 0 degrees).

The recordable track pitch Trpp when the skew angle θs is 0 degrees is taken as a reference track pitch Trpp0. The reference track pitch Trpp0 (i.e., the recordable track pitch Trpp when the skew angle θs is 0 degrees) is used as the reference in the evaluation. The difference DTrp of the track pitch is the difference between the reference track pitch Trpp0 and the recordable track pitch Trpp when the skew angle θs is another value.

As shown in FIG. 3B, the difference DTrp (the increase of the recordable track pitch Trpp when the skew angle θs is the other value using, as the reference, the recordable track pitch Trpp when the skew angle θs is 0 degrees) is large when the skew angle θs is large. The difference DTrp is large when the bevel angle θb is small.

The track pitch loss TPIL is defined so that

TPIL=(DTrp/Trpp0)×100(%).

As shown in FIG. 3C, the track pitch loss TPIL increases as the skew angle θs increases. The track pitch loss TPIL increases as the bevel angle θb increases.

Thus, the skew angle θs and the bevel angle θb affect the track pitch loss TPIL.

The characteristics when changing the magnetic pole length PL will now be described.

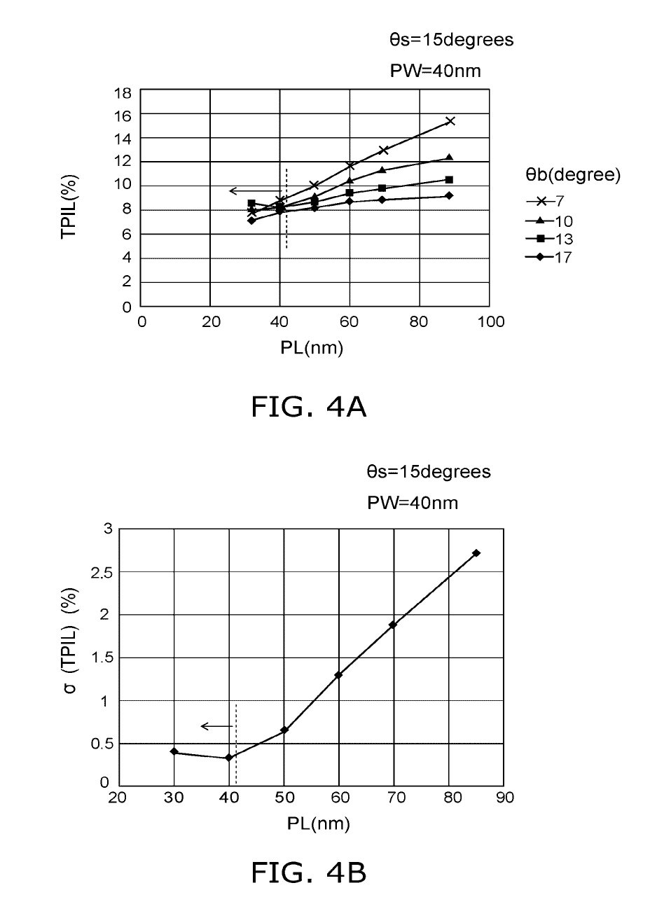

FIG. 4A and FIG. 4B are graphs of characteristics of the magnetic recording device.

In FIG. 4A, the horizontal axis is the magnetic pole length PL. The vertical axis is the track pitch loss TPIL when the skew angle θs is 15 degrees.

It can be seen from FIG. 4A that the track pitch loss TPIL is large when the magnetic pole length PL is long. In the case where the magnetic pole length PL is long, the change of the track pitch loss TPIL when the bevel angle θb is changed is greater. In other words, when the magnetic pole length PL is long, the practically-realizable track pitch Trp is greatly dependent on the bevel angle θb.

The track pitch loss TPIL is small when the magnetic pole length PL is short. In other words, when the magnetic pole length PL is short, the practically-realizable track pitch Trp is small and substantially is independent of the bevel angle θb.

For example, the track pitch loss TPIL is substantially constant when the magnetic pole length PL is 40 nm or less. The track pitch loss TPIL substantially is independent of the bevel angle θb when the magnetic pole length PL is 40 nm or less. The average of the track pitches Trp for all of the bevel angles θb when the magnetic pole length PL is 40 nm or less is 57.3 nm.

Thus, when the magnetic pole length PL is short (e.g., 40 nm or less), the track pitch loss TPIL is small and is substantially constant. The track pitch Trp at this time is about 57 nm. The track pitch Trp is calculated based on the EWAC (the Erasure Width of the AC pattern, e.g., referring to the specification of U.S. Pat. No. 8,804,281). In the embodiment, the magnetic pole length PL is set to be shorter than the track pitch Trp. In the embodiment, the magnetic pole length PL is set to be not more than 0.7 times the track pitch Trp. In other words, the magnetic pole length PL is set to be 40 nm or less when the track pitch Trp is 57 nm.

FIG. 4B is made based on the data of FIG. 4A.

In FIG. 4B, the horizontal axis is the magnetic pole length PL. The vertical axis is the standard deviation σ (TPIL) of the track pitch loss TPIL. The standard deviation σ (TPIL) is the standard deviation of the track pitch loss TPIL of each magnetic pole length PL. The standard deviation σ (TPIL) is calculated based on the value of the track pitch loss TPIL for bevel angles θb of 7 degrees, 10 degrees, 13 degrees, or 17 degrees.

As shown in FIG. 4B, the standard deviation σ (TPIL) is small when the magnetic pole length PL is 40 nm or less. Fluctuation of the bevel angle θb occurs due to the fluctuation when patterning the magnetic head 110. The characteristics change due to the fluctuation of the bevel angle θb. The fluctuation of the characteristics of the track pitch loss TPIL caused by the fluctuation of the bevel angle θb is suppressed when the magnetic pole length PL is 40 nm or less. Thereby, stable HDD characteristics can be obtained.

In the embodiment, the track pitch loss TPIL can be reduced. In other words, a high density magnetic recording device at practical conditions considering the skew angle θs can be provided.

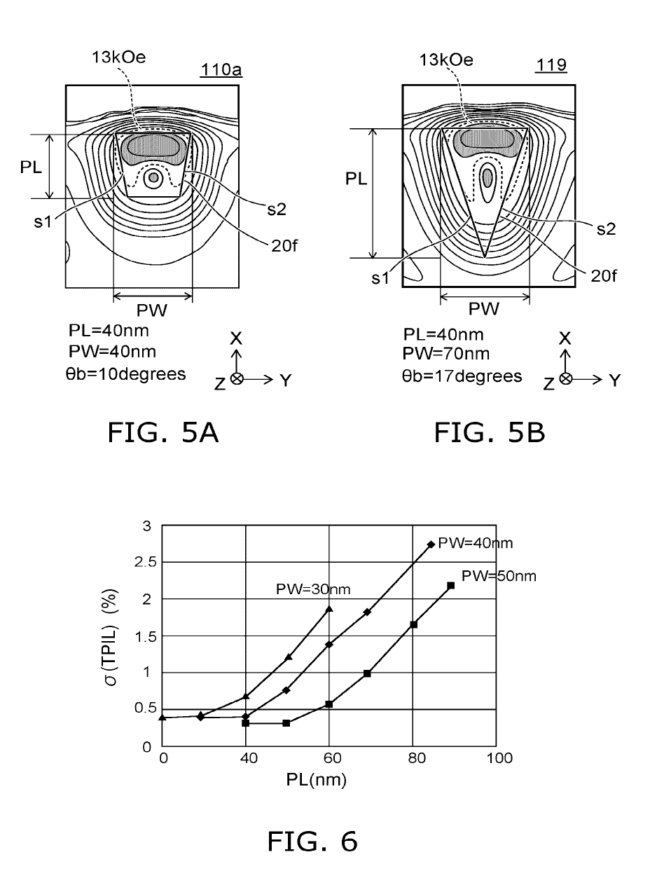

FIG. 5A and FIG. 5B are schematic views illustrating characteristics of magnetic recording devices.

These figures show simulation results of the magnetic field of the magnetic pole applied to the magnetic recording medium 80. In these simulations, the distance between the medium-opposing surface 20f and the magnetic recording medium 80 is 17 nm. The magnetic pole width PW is 40 nm. The write gap WG is 22 nm. The side gap SG is 30 nm. In a magnetic head 110a illustrated in FIG. 5A, the magnetic pole length PL is 40 nm; and the bevel angle θb is 10 degrees. In a magnetic head 119 illustrated in FIG. 5B, the magnetic pole length PL is 70 nm; and the bevel angle θb is 17 degrees. The magnetic head 110a corresponds to the embodiment; and the magnetic head 119 corresponds to a reference example.

For example, these figures illustrate the state when the skew angle θs is 0. In such a case, the X1-axis direction relating to the magnetic pole 20 is parallel to the X-axis direction relating to the magnetic recording medium 80. Contour lines of the recording magnetic field are displayed in these figures. In these figures, the recording magnetic field is stronger for the dark (deep-hued) portions than for the bright (light) portions. A contour line where the recording magnetic field is 13 kOe is drawn using a broken line. The configuration of the medium-opposing surface 20f of the magnetic pole 20 is displayed in these figures.

As shown in these figures, the width of the recording magnetic field (13 kOe) illustrated by the broken line matches the track pitch Trp calculated based on the EWAC. It is considered that the recording to the magnetic recording medium 80 is determined by the recording magnetic field (13 kOe) illustrated by the broken line. The recording magnetic field (13 kOe) illustrated by the broken line is called a recording bubble. The configuration of the recording bubble and the configuration of the medium-opposing surface 20f of the magnetic pole 20 will now be compared.

In the magnetic head 119 having the long magnetic pole length PL, one side of the configuration of the recording bubble is aligned with the side surface (the first side s1 and the second side s2) of the magnetic pole 20. In other words, the angle between the X-axis direction and the side of the configuration of the recording bubble substantially matches the bevel angle θb. As described in reference to FIG. 4A, it is considered that there is a relationship between this phenomenon and the high dependence of the practically-realizable track pitch Trp on the bevel angle θb when the magnetic pole length PL is long.

Conversely, in the magnetic head 110a having the short magnetic pole length PL, the side of the configuration of the recording bubble bulges outward in a curved configuration. The side of the configuration of the recording bubble is rounded. The configuration of the recording bubble approaches a circle when the magnetic pole length PL is short. Therefore, it is considered that the bevel angle θb dependence of the practically-realizable track pitch Trp is small.

FIG. 6 is a graph of characteristics of the magnetic recording device.

FIG. 6 shows the standard deviation σ (TPIL) of the track pitch loss TPIL when the magnetic pole width PW is changed.

In FIG. 6, the horizontal axis is the magnetic pole length PL. The vertical axis is the standard deviation σ (TPIL) of the track pitch loss TPIL. The standard deviation σ (TPIL) of the track pitch loss TPIL is small when the magnetic pole length PL is less than about the magnetic pole width PW. When the configuration of the recording bubble is rounded, the bevel angle θb dependence of the track pitch Trp becomes small. When the magnetic pole length PL is not more than the magnetic pole width PW, the bevel angle θb dependence of the track pitch Trp is small. The track pitch Trp calculated from the EWAC is about 0.7 times the magnetic pole width PW. In the embodiment, for example, the magnetic pole length PL is set to be not more than 0.7 times the track pitch Trp.

Such a relationship between the magnetic pole length PL and the configuration of the recording bubble is not conventionally known. Therefore, it had been considered that the recording magnetic field applied to the magnetic recording medium 80 increases as the surface area of the medium-opposing surface 20f of the magnetic pole 20 increases. However, as shown in FIG. 5A and FIG. 5B, the magnetic pole length PL of the magnetic pole 20 greatly affects the recording magnetic field. In the embodiment, the track pitch loss TPIL is reduced by reducing the magnetic pole length PL of the magnetic pole 20. Thereby, a magnetic recording device in which higher density is possible can be provided.

The configuration of the recording bubble does not change greatly even in the case where the recording conditions such as the fly height of the magnetic head 110, etc., are changed. As the track pitch Trp is changed, the size of the recording bubble changes while the configuration of the recording bubble is maintained in a similar shape.

In the example recited above, the bevel angle θb dependence becomes markedly small when the magnetic pole length PL is 70% of the track pitch Trp or less. The trend of this relationship substantially does not change even when the track pitch Trp is changed.

In the embodiment, the bevel angle θb of the magnetic pole 20 can be set to be smaller than the maximum value (the maximum skew angle θsm) of the skew angle θs of the magnetic recording medium 80.

For example, in the example of FIG. 2B, the first bevel angleθθb1 relating to the first side 51 of the magnetic pole 20 is set to be the same as the maximum value of the absolute value of the inner skew angle θsi. In such a case, the first side s1 at the position where the absolute value of the inner skew angle θsi is a maximum is aligned with the direction of the column 84a of the recorded bits 84 (the down-track direction).

In the reference example having the long magnetic pole length PL, a recording magnetic field having a configuration that corresponds to the configuration of the magnetic pole 20 is generated. In the reference example, in the case where the first bevel angle θb1 is less than the absolute value of the inner skew angle θsi, a portion of the recording magnetic field having a shape similar to the magnetic pole 20 undesirably passes outside the column 84a of the recorded bits 84. Thereby, the characteristics of the adjacent track degrade.

Conversely, a recording magnetic field approaching a circle is generated when the magnetic pole length PL is small. Therefore, the bevel angle θb can be reduced. In the embodiment, the magnetic pole length PL is set to be short. Thereby, even in the case where the first bevel angle θb1 is set to be less than the maximum value of the absolute value of the inner skew angle θsi, appropriate recording is possible even at the position where the skew angle θs is large.

For example, in the embodiment, the bevel angle θb may be set to be not more than 0.5 times the maximum value (the maximum skew angle θsm) of the skew angle θs.

For example, the bevel angle θb is not less than 0 degrees and not more than 17 degrees. On the other hand, the maximum value (the maximum skew angle θsm) of the absolute value of the skew angle θs is 20 degrees or less.

Thus, the arm 155 is provided in the embodiment. The arm 155 includes the arm axis 155c, and the extension portion 155e that extends along the arm extension direction 155d and rotates with the arm axis 155c as the center (referring to FIG. 2B). The magnetic pole 20 is fixed to the extension portion 155e (the tip portion which is a portion of the extension portion 155e). On the other hand, the magnetic recording medium 80 rotates with the medium rotation axis 80c as the center. The direction of the track pitch Trp passes through the medium rotation axis 80c. The direction of the track pitch Trp is aligned with the straight line 80L that is perpendicular to the medium rotation axis 80c (referring to FIG. 1B).

The down-track direction is substantially perpendicular to the straight line 80L. The direction of the track pitch Trp is aligned with the straight line 80L. The medium-opposing surface 20f of the magnetic pole 20 has a side (the first side s1, the second side s2, etc.) intersecting the straight line 80L (referring to FIG. 1C). The first angle (at least one of the first bevel angle θb1 or the second bevel angle θb2) between the side and the X1-axis direction (the first direction from the magnetic pole 20 toward the shield 10) is smaller than the maximum value of the absolute value of the second angle (the skew angle θs) between the down-track direction and the arm extension direction 155d (corresponding to the maximum skew angle θsm).

In the embodiment, the first angle is, for example, not more than 0.5 times the maximum value of the absolute value of the second angle. The first angle is, for example, not less than 0 degrees and not more than 17 degrees. The maximum value of the absolute value of the second angle is, for example, 20 degrees or less.

In the embodiment, the magnetic pole length PL is, for example, 40 nanometers or less.

The medium-opposing surface 20f has the magnetic pole width PW. The magnetic pole width PW is the length (the maximum value) of the medium-opposing surface 20f along the Y1-axis direction (a direction perpendicular to the medium-opposing surface 20f and perpendicular to the X1-axis direction from the magnetic pole 20 toward the shield 10). In the embodiment, the magnetic pole length PL is not more than the magnetic pole width PW.

In perpendicular magnetic recording, writing to the magnetic recording medium 80 is performed using the magnetic field (the recording magnetic field) generated by the magnetic pole 20. The flux from the magnetic pole 20 passes through the soft under layer (SUL) of the magnetic recording medium 80 and diffuses. The flux passes through the medium-opposing surface 20f of the magnetic pole 20. Therefore, generally, it had been considered that the magnetic field applied to the magnetic recording medium 80 increases as the surface area of the medium-opposing surface 20f of the magnetic pole 20 increases.

On the other hand, the magnetic head 110 is fixed to the arm 155 (the swing arm). The arm 155 swings around one rotation axis (the arm axis 155c). The angle between the down-track direction and the center line of the magnetic head 110 corresponds to the skew angle θs. The magnetic pole length PL is set to be short in the embodiment. Thereby, appropriate recording is possible even when the bevel angle θb of the magnetic pole 20 is smaller than the skew angle θs. For example, the maximum value (the maximum skew angle θsm) of the skew angle θs is about 15 degrees. In such a case, the bevel angle θb of the magnetic pole 20 may be set to be about 15 degrees.

Generally, it is considered that the recording characteristics improve when the bevel angle θb is set to be small because the surface area of the entire medium-opposing surface 20f of the magnetic pole 20 can be increased. In other words, when the bevel angle θb is small, the medium-opposing surface 20f of the magnetic pole 20 approaches a rectangle; and the surface area of the medium-opposing surface 20f is large. For example, the surface area of the medium-opposing surface 20f can be increased by increasing the magnetic pole length PL as the bevel angle θb is reduced.

On the other hand, when the bevel angle θb is small, the medium-opposing surface 20f of the magnetic pole 20 is undesirably positioned outside the track at the position where the skew angle θs is large. Therefore, the track pitch loss TPIL increases.

It is considered that the track pitch loss TPIL can be suppressed even when the bevel angle θb is small by lengthening the arm 155. However, in this method, the shock resistance degrades when the arm 155 is long. Accordingly, generally, the surface area of the medium-opposing surface 20f of the magnetic pole 20 is limited by the bevel angle θb.

The embodiment focuses on the characteristics described in reference to FIG. 4A to FIG. 5B. In other words, the track pitch loss TPIL can be reduced by setting the magnetic pole length PL of the magnetic pole 20 to be small.

In the embodiment, the track pitch loss TPIL can be reduced while maintaining a small bevel angle θb.

For example, the magnetic pole length PL of the magnetic pole 20 (the maximum length of the magnetic pole 20 in the down-track direction) is set to be short. For example, the magnetic pole length PL is set to be 70% of the track pitch Trp or less. Thereby, the track pitch loss TPIL can be small; and high density recording is possible.

The bevel angle θb is set to be smaller than the maximum value (the maximum skew angle θsm) of the skew angle θs of the magnetic recording device 150 (the hard disk). By setting the bevel angle θb to be small simultaneously with setting the magnetic pole length PL to be small, good recording performance can be ensured further.

For example, the track density is taken to be 391 kTPI at the middle circumference of a 2.5-inch hard disk having a linear recording density of 2000 kBPI. In such a case, the track pitch Trp is 65 nm. Magnetic heads having a first condition and a second condition recited below are investigated for such a case.

In the magnetic head of the first condition, the magnetic pole width PW is 60 nm; the bevel angle θb is 17 degrees; and the magnetic pole length PL is 90 nm. In such a case, the noise characteristic SNR is 10.2 dB. In the first condition, the magnetic pole length PL is larger than the track pitch Trp (65 nm).

In the magnetic head of the second condition, the magnetic pole width PW is 58 nm; the bevel angle θb is 7 degrees; and the magnetic pole length PL is 40 nm. In such a case, the noise characteristic SNR is 11 dB. In the second condition, the magnetic pole length PL is about 62.5% of the track pitch Trp (65 nm).

The total capacity is larger for the second condition than for the first condition. The difference of the capacity is 3.2%. The surface area of the medium-opposing surface 20f of the magnetic pole 20 for the first condition is 2924 nm²; and the surface area of the medium-opposing surface 20f of the magnetic pole 20 for the second condition is 2124 nm². The capacity is larger for the second condition even though the surface area of the medium-opposing surface 20f of the magnetic pole 20 is smaller. Therefore, it can be seen that the surface area of the medium-opposing surface 20f is not the only contribution to the writing capability. For example, it is considered that the contribution of the trailing side of the magnetic pole 20 is larger than the contribution of the leading side. In the case where the bevel angle θb is small, it is considered that the writing capability improves even in the case where the surface area of the entire medium-opposing surface 20f is somewhat small.

For example, the track density is taken to be 488 kTPI at the middle circumference of a 2.5-inch hard disk having a linear recording density of 2000 kBPI. In such a case, the track pitch Trp is 52 nm. Magnetic heads of a third condition and a fourth condition recited below are investigated for such a case.

In the magnetic head of the third condition, the magnetic pole width PW is 33 nm; the bevel angle θb is 15 degrees; and the magnetic pole length PL is 60 nm. In such a case, the noise characteristic SNR is 9.8 dB. In the third condition, the magnetic pole length PL is larger than the track pitch Trp (52 nm).

In the magnetic head of the fourth condition, the magnetic pole width PW is 35 nm; the bevel angle θb is 7 degrees; and the magnetic pole length PL is 30 nm. In such a case, the noise characteristic SNR is 10.7 dB. In the fourth condition, the magnetic pole length PL is about 57.17% of the track pitch Trp (52 nm).

The total capacity is larger for the fourth condition than for the third condition. The difference of the capacity is 4.5%.

The second condition and the fourth condition recited above correspond to the embodiment. According to the embodiment, high density recording having good characteristics is possible.

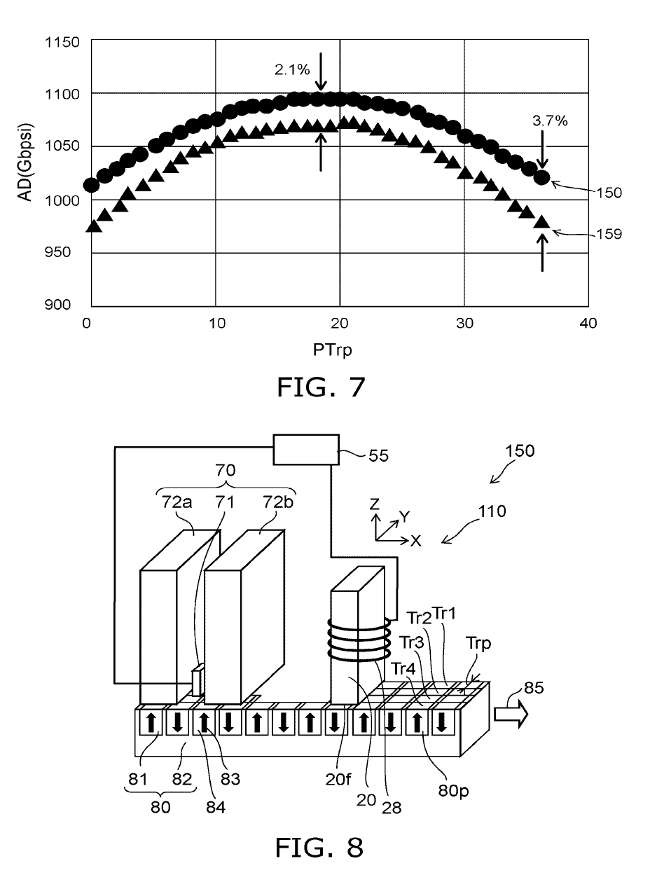

FIG. 7 is a graph of characteristics of the magnetic recording devices.

FIG. 7 illustrates the recording densities of the magnetic recording devices. In FIG. 7, the horizontal axis is a position PTrp (corresponding to the zone number) in the direction of the track pitch Trp of the magnetic recording medium 80. The vertical axis is a recording density AD (Gbpsi). The characteristic of the magnetic recording device 150 according to the embodiment (e.g., the magnetic head 110a) and the characteristic of a magnetic recording device 159 of a reference example (e.g., the magnetic head 119) are shown in the figure. In the magnetic recording device 150, the bevel angle θb is 10 degrees; and the track pitch Trp is 30 nm. In the magnetic recording device 159, the bevel angle θb is 17 degrees; and the track pitch Trp is 60 nm.

In the magnetic recording device 150 (e.g., the magnetic head 110a), the recording density AD is 1021 Gbpsi when the skew angle θs is 15 degrees. The recording density AD corresponds to 479 kTPI/2130 kBPI.

The recording density AD of the magnetic recording device 150 is higher than the recording density AD of the magnetic recording device 159.

When the skew angle θs is 0 degrees, the recording density AD of the magnetic recording device 150 is higher than the recording density AD of the magnetic recording device 159. The level of the improvement is 2.1%. Even when the skew angle θs is 15 degrees, the recording density AD of the magnetic recording device 150 is higher than the recording density AD of the magnetic recording device 159. The level of the improvement is 3.7%. The average level of the improvement for the entire skew angle θs is 2.6%.

In the magnetic recording device 150, the track pitch loss TPIL is particularly small when the skew angle θs is large (e.g., when 15 degrees). Therefore, the level of the improvement of the recording density AD is high at the inner circumferential portion and outer circumferential portion of the magnetic recording medium 80.

FIG. 8 is a schematic perspective view illustrating the magnetic recording device according to the first embodiment.

The shield 10, the shield 43, the first side shield 41, the second side shield 42, etc., are not shown in FIG. 8.

A write coil 28 is provided in the magnetic pole 20 of the magnetic head 110. A recording magnetic field is generated in the magnetic pole 20 by a current supplied to the write coil 28. The recording magnetic field that is generated is applied to the magnetic recording medium 80. Multiple tracks (e.g., first to fourth tracks Tr1 to Tr4, etc.) are formed in the magnetic recording medium 80. The pitch of the multiple tracks corresponds to the track pitch Trp.

As shown in FIG. 8, the magnetic head 110 may further include a reproducing unit 70. The reproducing unit 70 includes a first reproducing shield 72a, a second reproducing shield 72b, and a reproducing element 71. The reproducing element 71 is provided between the first reproducing shield 72a and the second reproducing shield 72b. The state of the magnetization 83 of the recorded bit 84 in which the information is recorded is sensed by the reproducing element 71.

A controller 55 may be provided in the magnetic recording device 150. An electrical signal is supplied from the controller 55 to the coil 28. The controller 55 may sense the state of the electrical resistance of the reproducing element 71.

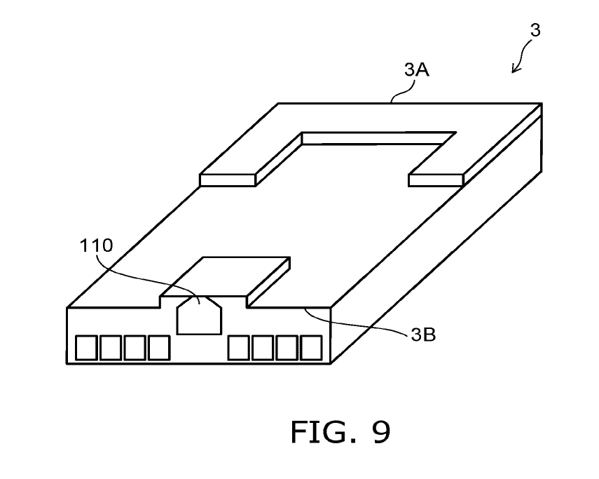

FIG. 9 is a schematic perspective view illustrating a portion of the magnetic recording device according to the first embodiment.

FIG. 9 illustrates a head slider to which the magnetic head is mounted.

The magnetic head 110 is mounted to the head slider 3. The head slider 3 includes, for example, Al₂O₃/TiC, etc. The head slider 3 moves relative to the magnetic recording medium 80 while flying over or contacting the magnetic recording medium 80.

The head slider 3 has, for example, an air inflow side 3A and an air outflow side 3B. The magnetic head 110 is disposed at the side surface of the air outflow side 3B of the head slider 3 or the like. Thereby, the magnetic head 110 that is mounted to the head slider 3 moves relative to the magnetic recording medium 80 while flying over or contacting the magnetic recording medium 80.

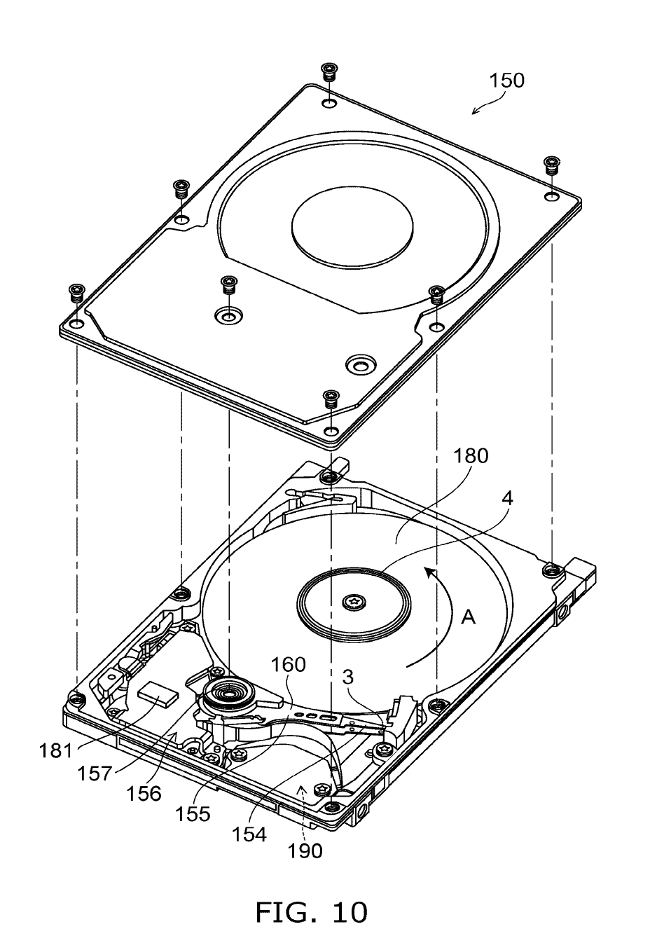

FIG. 10 is a schematic perspective view illustrating the magnetic recording device according to the embodiment.

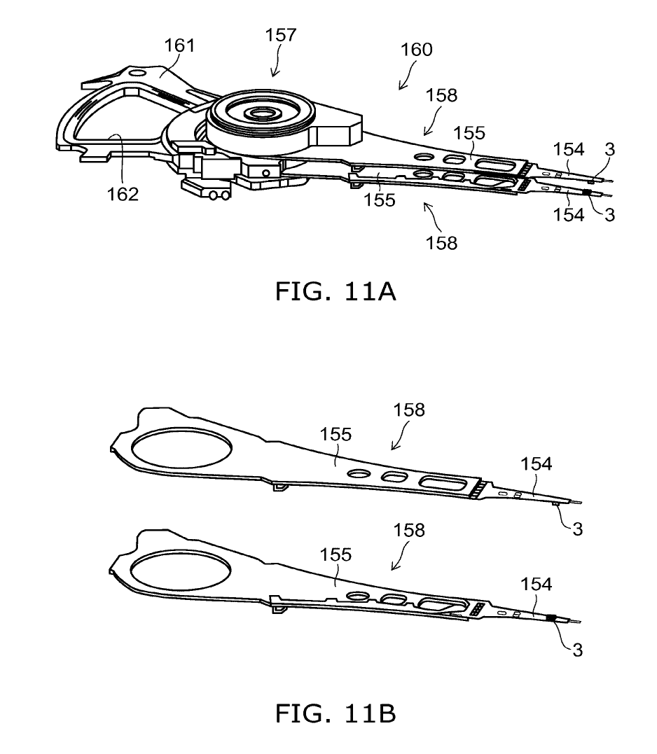

FIG. 11A and FIG. 11B are schematic perspective views illustrating portions of the magnetic recording device.

As shown in FIG. 10, the magnetic recording device 150 according to the embodiment is a device that uses a rotary actuator. A recording medium disk 180 is mounted to a spindle motor 4 and is rotated in the direction of arrow A by a motor that responds to a control signal from a drive device controller. The magnetic recording device 150 according to the embodiment may include multiple recording medium disks 180. The magnetic recording device 150 may include a recording medium 181. For example, the magnetic recording device 150 is a hybrid HDD (Hard Disk Drive). The recording medium 181 is, for example, a SSD (Solid State Drive). The recording medium 181 includes, for example, nonvolatile memory such as flash memory, etc.

The head slider 3 that performs the recording and reproducing of the information stored in the recording medium disk 180 has a configuration such as that described above and is mounted to the tip of a suspension 154 having a thin-film configuration. Here, for example, one of the magnetic heads according to the embodiment described above is mounted at the tip vicinity of the head slider 3.

When the recording medium disk 180 rotates, the medium-opposing surface (the ABS) of the head slider 3 is held at a prescribed fly height from the surface of the recording medium disk 180 by the balance between the downward pressure due to the suspension 154 and the pressure generated by the medium-opposing surface of the head slider 3. A so-called “contact-sliding” head slider 3 that contacts the recording medium disk 180 may be used.

The suspension 154 is connected to one end of the arm 155 (e.g., the actuator arm). The arm 155 includes, for example, a bobbin unit holding a drive coil, etc. A voice coil motor 156 which is one type of linear motor is provided at one other end of the arm 155. The voice coil motor 156 may include a drive coil that is wound onto the bobbin unit of the arm 155, and a magnetic circuit made of a permanent magnet and an opposing yoke that are disposed to oppose each other with the coil interposed. The suspension 154 has one end and one other end; the magnetic head is mounted to the one end of the suspension 154; and the arm 155 is connected to the one other end of the suspension 154.

The arm 155 is held by ball bearings provided at two locations on and under a bearing unit 157; and the arm 155 can be caused to rotate and slide unrestrictedly by the voice coil motor 156. As a result, the magnetic head is movable to any position of the recording medium disk 180.

FIG. 11A illustrates the configuration of a portion of the magnetic recording device and is an enlarged perspective view of a head stack assembly 160.

FIG. 11B is a perspective view illustrating a magnetic head assembly (head gimbal assembly (HGA)) 158 which is a portion of the head stack assembly 160.

As shown in FIG. 11A, the head stack assembly 160 includes the bearing unit 157, the head gimbal assembly 158, and a support frame 161. The head gimbal assembly 158 extends from the bearing unit 157. The support frame 161 extends from the bearing unit 157 in the opposite direction of the HGA. The support frame 161 supports a coil 162 of the voice coil motor.

As shown in FIG. 11B, the head gimbal assembly 158 includes the arm 155 that extends from the bearing unit 157, and the suspension 154 that extends from the arm 155.

The head slider 3 is mounted to the tip of the suspension 154. One of the magnetic heads according to the embodiment is mounted to the head slider 3.

In other words, the magnetic head assembly (the head gimbal assembly) 158 according to the embodiment includes the magnetic head according to the embodiment, the head slider 3 to which the magnetic head is mounted, the suspension 154 that has the head slider 3 mounted to one end of the suspension 154, and the arm 155 that is connected to the other end of the suspension 154.

The suspension 154 includes lead wires (not shown) that are for writing and reading signals, for a heater that adjusts the fly height, for example, for a spin torque oscillator, etc. The lead wires are electrically connected to electrodes of the magnetic head embedded in the head slider 3.

A signal processor 190 that performs writing and reading of the signals to and from the magnetic recording medium by using the magnetic head also is provided. For example, the signal processor 190 is provided on the backside of the drawing of the magnetic recording device 150 illustrated in FIG. 10. The input/output lines of the signal processor 190 are electrically coupled to the magnetic head by being connected to electrode pads of the head gimbal assembly 158.

Thus, the magnetic recording device 150 according to the embodiment includes a magnetic recording medium, the magnetic head according to the embodiment recited above, a movable unit that is relatively movable in a state in which the magnetic recording medium and the magnetic head are separated from each other or in contact with each other, a position controller that aligns the magnetic head at a prescribed recording position of the magnetic recording medium, and a signal processor that writes and reads signals to and from the magnetic recording medium by using the magnetic head.

In other words, the recording medium disk 180 is used as the magnetic recording medium recited above.

The movable unit recited above may include the head slider 3.

The position controller recited above may include the head gimbal assembly 158.

Thus, the magnetic recording device 150 according to the embodiment includes the magnetic recording medium, the magnetic head assembly according to the embodiment, and the signal processor that writes and reads signals to and from the magnetic recording medium by using the magnetic head mounted to the magnetic head assembly.

According to the embodiment, a magnetic recording device in which higher density is possible is provided.

In this specification, “perpendicular” and “parallel” include not only strictly perpendicular and strictly parallel but also, for example, the fluctuation due to manufacturing processes, etc.; and it is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads such as shields, magnetic poles, side shields,_included in magnetic recording devices such as magnetic recording media, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic recording devices practicable by an appropriate design modification by one skilled in the art based on the magnetic recording devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic recording device, comprising:
a magnetic recording medium; and
a magnetic head, the magnetic head including a magnetic pole and a trailing shield, the magnetic pole having a medium-opposing surface opposing the magnetic recording medium,
the medium-opposing surface having a magnetic pole length along a first direction, the first direction being from the magnetic pole toward the trailing shield,
the magnetic pole length being shorter than a track pitch of the magnetic recording medium.

2. The device according to claim 1, wherein the magnetic pole length is not more than 0.7 times the track pitch.

3. The device according to claim 1, wherein a bevel angle of the magnetic pole is less than a maximum value of an absolute value of a skew angle of the magnetic recording medium.

4. The device according to claim 3, wherein the bevel angle is not more than 0.5 times the maximum value.

5. The device according to claim 3, wherein the bevel angle is not less than 0 degrees and not more than 17 degrees.

6. The device according to claim 3, wherein the maximum value is 20 degrees or less.

7. The device according to claim 1, further comprising an arm,
the arm including an arm axis and an extension portion, the extension portion extending along an arm extension direction and rotating with the arm axis as a center,
the magnetic pole being fixed to the extension portion,
the magnetic recording medium rotating with a medium rotation axis as a center,
a direction of the track pitch being aligned with a straight line, the straight line passing through the medium rotation axis and being perpendicular to the medium rotation axis,
a down-track direction being substantially perpendicular to the straight line,
the medium-opposing surface having a side intersecting the straight line,
a first angle between the first direction and the side being less than a maximum value of an absolute value of a second angle between the down-track direction and the arm extension direction.

8. The device according to claim 7, wherein the first angle is not more than 0.5 times the maximum value of the second angle.

9. The device according to claim 7, wherein the first angle is not less than 0 degrees and not more than 17 degrees.

10. The device according to claim 7, wherein the maximum value of the absolute value of the second angle is 20 degrees or less.

11. The device according to claim 1, wherein the magnetic pole length is not more than 40 nanometers.

12. The device according to claim 1, wherein
the medium-opposing surface has a magnetic pole width along a direction parallel to the first direction and perpendicular to the medium-opposing surface, and
the magnetic pole length is not more than the magnetic pole width.

13. The device according to claim 1, wherein the magnetic recording medium includes a perpendicular magnetic recording layer.
